(19) United States
(12) Patent Application Publication
(10) Pub. No.: US 2002/0116306 A1
(43) Pub. Date: Aug. 22, 2002

(54) Fund management system and method for maintaining a private web site in auto-pilot mode indefinitely

(76) Inventor: Sang K. Sheem, Pleasanton, CA (US)

Correspondence Address: Sang K. Sheem, 1790 Paseo Del Cajon, Pleasanton, CA, 94566, US

(21) Appl. No.: 09/791,976

(22) Filed: Feb. 22, 2001

(51) Int. Cl. G06F 17/60

(52) U.S. Cl. 705/35; 705/39

(57) ABSTRACT

A system and method for a family fund management based on an internet family web site is described in which family funds dedicated to some of the relatives dispense monetary rewards to pre-verified beneficiaries. The financial details on the family funds in terms of the principal amount, income from the principal, dispensable amount, past transactions, are readily available for display on the web site in a self-explanatory fashion. The clarity of the financial transactions and the transparency of the financial details allow the family web site being steered largely in an auto-pilot mode, thus contribute to preserving the family web site over many generations at a reasonable financial management cost and to reducing the possibility of financial fraud substantially. It could be preferable to dispense the dedicated family funds only during one short period during the year, such as a few days around Christmas or New Year day.

### TECHNICAL FIELD

This invention is related to the management of fund through internet computer communication network.

### BACKGROUND ART

With the advance of electronic computer communication network such as worldwide web (www), flexible and economical means to conduct financial management has experienced a great advancement. Examples are an invention of David, et. al. (U.S. Pat. No. 6,173,269), and prior arts cited in the patent.

It would be quite beneficial to apply the financial management system and method of the modern computer communication network to strengthening the family tie over many generation, eternally if possible. After a few generations, the deceased becomes forgotten even by the descendants. Internet private sites are popular among many people, but nobody expects their descendants would maintain and visit his internet family site 50, 100, or 200 years after his death. It is much easier to set up a web site than making sure it is visited, updated, and maintained. Even though a family web site is maintained, it would take substantial demand and even harassment from the parents before their children visit their family web site and spend enough time to be familiarized with ancestors who have been deceased for a long time. In general kids would not be very interested in dead people, even their own ancestors, whom they have never met. They can hardly make any mental connection. Therefore, it is critically important to make sure that the incentive is clearly understood and strong if one wants to induce the minors to feel intimacy toward their dead ancestors.

It would be nice to find a way to solve all these problems, and make sure that a deceased person would be remembered for a long time, hopefully eternally, by his descendants, while being loved and appreciated by them, without burdening them financially.

### SUMMARY OF THE INVENTION

Accordingly, it is the primary objective of the present invention to devise an internet financial management system through which a private web site can be preserved over hundreds of years and beyond, in an auto-pilot mode.

It is another objective of the present invention to devise an internet financial management system through which living people, especially the minors, are enticed to meet dead ancestors in face-to-face fashion in the cyber space regularly.

It is an accompanying objective of the present invention to fulfill the objectives described above at a reasonable cost so that ordinary people with limited means can afford such a web site service for preserving their family roots.

These objectives could be achieved by a system and method utilizing a private web site as disclosed in the present patent application, in which there are two key elements. The first element is “funds dedicated to particular persons' (to be called ‘funded-relatives’), the funds being dispensed to living descendants. It may be required that the living descendants visit the funded-relatives' web site and follow a procedure, such as writing a greeting message, or, in Eastern culture, performing an animated bowing ceremony. The second key element is an ‘open accounting structure’ in which comprehensive year-to-year information on the dedicated funds in terms of the total principal amount, the annual interest income, the dispensable amount, detailed transactions (that is, who has got how much when) is posted openly and clearly in greatest details somewhere on the family web site, so that all the eligible relatives can see and understand the whole picture easily by eye-scanning alone. Since the purpose of the invention is to preserve the system over hundreds of years and beyond for ordinary families, as well as the wealthy and the famous, such self-explanatory records with complete details posted on the web site are the indispensable element for this invention to work. It is the purpose of this invention to avoid high-cost accounting services in tracking the dedicated family funds over hundreds of years and beyond. There could be reluctance among some relatives to publicize the financial details in the web site, especially in the Eastern culture where all money matters are supposed to be implicit. However, such an open accounting system displayed on the family web site is needed in order to preserve a family web site across many generations at a reasonable cost. In essence, this invention is aiming to make it possible even for ordinary people to achieve what the old kings have achieved from their Pyramids: namely, devising a means to connect themselves to the descendants eternally after death.

In reality, the present invention targets the minors as the main participants in this cyber reunion with the dead ancestors, as the amount of money to be dispensed is not expected to be large in most of the cases, and only minors would be excited and motivated enough by such a modest sum. This is not a drawback since the formative age is the best period to develop the respect toward one's family root.

It could be preferable to dispense the dedicated family funds only during one short period during the year (time-window), such as Christmas or New Year day (by either Western or Eastern Calendar). This would help the family web site to survive hundreds of years and beyond as even the most forgettable or neglecting mind would remember ‘what to do and when’ to get the monetary reward. Actually this ‘time-window’ concept could be considered the fourth key element to prevent a silent death of the family web site, which is a quite common fate of most private web sites. Prolonging a lifetime of a private web site even for 100 years would not be a trivial task.

The summary described above is mainly for dead ancestors. A provision may be made for a living relative who wants to set up a family fund for himself while he is still alive. The financial details could be hidden from others while he is alive.

More details will be described below in conjunction with accompanying drawings and the claims.

### BRIEF DESCRIPTION OF DRAWINGS

FIG. 1 shows an overall fund management system for the present invention for a case that the value of the family fund is not diminishing with time.

FIG. 2 shows another example in which the value of the family fund is diminishing over the years.

FIG. 3 shows a variation of the concept that is depicted in FIG. 1 and FIG. 2.

FIG. 4 shows time history of the family fends for the cases of FIG. 1 and FIG. 2.

FIG. 5 depicts the membership verification procedure.

FIG. 6 shows a representative procedure of the present invention through which a monetary reward is made.

FIG. 7 shows a greeting card generated for a minor who has visited and left a greeting message to a deceased relative.

FIG. 8 shows a traditional bowing ceremony of the Eastern culture displayed on a computer monitor.

FIG. 9 shows a financial content of FIG. 1 for earlier years before Jenny Doe dies.

FIG. 10 shows the same as shown in FIG. 1 except for the financial content.

### DETAILED DESCRIPTION

The present invention provides a private fund management system and method for preserving a private web site hundreds of years and beyond, largely in an auto-pilot mode.

Two key elements are implemented in the present inventions.

The first key element is a private fund dedicated to one individual or one group of people such as married couples. Let's call the relatives with such a dedicated fund ‘funded-relative’. Typical funded-relatives would be either deceased or living at a far distance such as foreign country. The dedicated funds are established to make their status from ‘inaccessible’ to ‘communicable’ in cyber space. Living relatives, who will be called ‘beneficiaries’ in this patent application, are rewarded when they visit these funded-relatives on their private web site. Their private web site may be the same as family web site if they and other relatives share one web site together. In this patent application, we will not differentiate between the two terminologies, namely “private web site” and “family web sites”, and will use them interchangeably, since the present invention deal with preserving family roots among relatives.

The private funds should be readily available for display on demand, for example by clicking on a command button, on the web site.

The second key element is openness of the financial details. The web site should list all the available funds, along with detailed information such as the principal amount, yearly income stemming from the funds in a form of interest or the likes, past transactions (who got how much when) from the birth of the funds to the present time. This is mainly to keep accounting simple and transparent so that all the relevant relatives can participate easily, and can have confidence on the system. Some people might be reluctant, for various reasons, to let their funds posted that way on the web site. However, the openness of all the funds, large or small, is a compulsory condition prolong the life of the web site at a reasonable funding management cost. The financial details should be readily available for display on demand, for example by clicking on a command button, on the web site.

It would be preferable for the web site to keep a list of beneficiaries who have been pre-verified for their eligibility as the recipients of the monetary rewards of the family funds. This arrangement would prevent fraudulent claims by outsiders, and also make it easier to estimate the reward per beneficiary per fund. The list should be readily available for display on demand, for example by clicking on a command button, on the web site.

One optional element, which is quite a powerful tool, is to impose a time-window during which the monetary reward can be obtained. No or minimal monetary rewards are allowed outside the time window. This has a number of merits. It is easier to manage the fund. It is easier for the relatives to remember when they are supposed to visit their ancestors and elders. Knowing that their kids can get extra money only in a predesignated time-window, it is easier for parents to supervise their kids on the money matter, since extra money could be bad for kids. The time-window could be the birth day of the funded-relatives. It could be a family reunion day the relatives agree upon. It could be either Christmas or New Year day, when families get together traditionally.

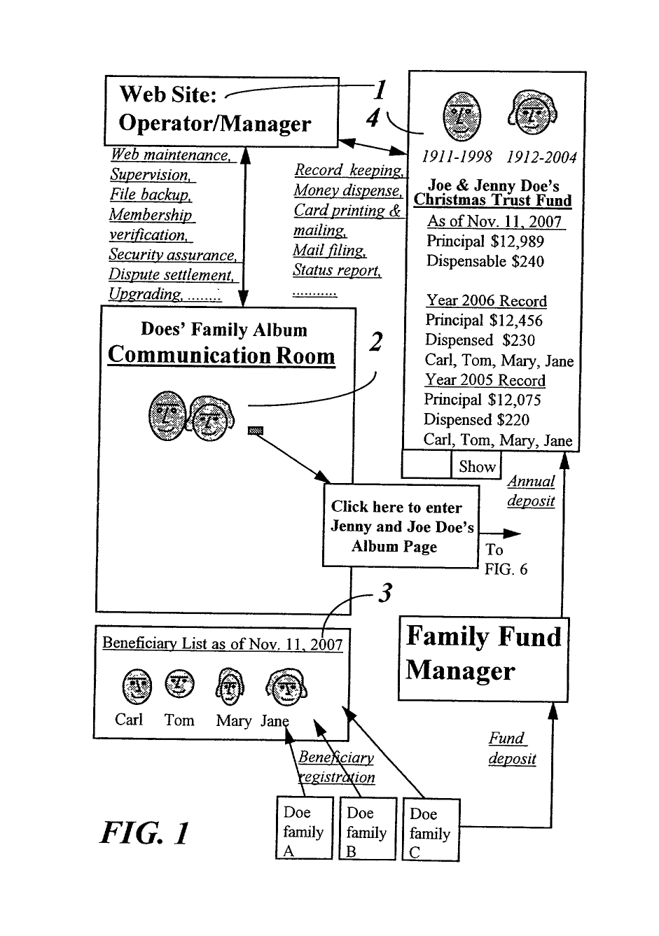

With the key elements as set forth as above, the present invention can begin its teaching with FIG. 1, which shows a family web site 1, funded-relatives Jenny and Joe Doe, 2, pre-verified beneficiaries Carl, Tom, Mary, and Jane, 3, and the complete details of the fund, 4, from its starting year of 2005, that is one year after Jenny Doe, the last survivor of the couple is dead.

It does not mean that the family web site should not include other features, such as the photos, video clips, etc. of other relative members. The present invention describes only the portion that is deemed essential and critical to make the web site last long.

In the example of FIG. 1, the value of the fund is kept largely constant against the usual inflation and despite of the expenditure in the form of rewarding to the beneficiaries. The income from the fund is partially re-invested back into the fund principal to compensate the value reduction due to the inflation, and only the rest of the income is dispensed among the listed beneficiaries. Accordingly, the fund principal is shown increasing over years largely following the inflation, and thus maintaining its value over years. This is shown in FIG. 4 as ‘Case of FIG. 1’.

The income from the family funds may have to be limited to government-insured savings or investments since one can hardly afford to lose the fund. Lower income would be the price for the security.

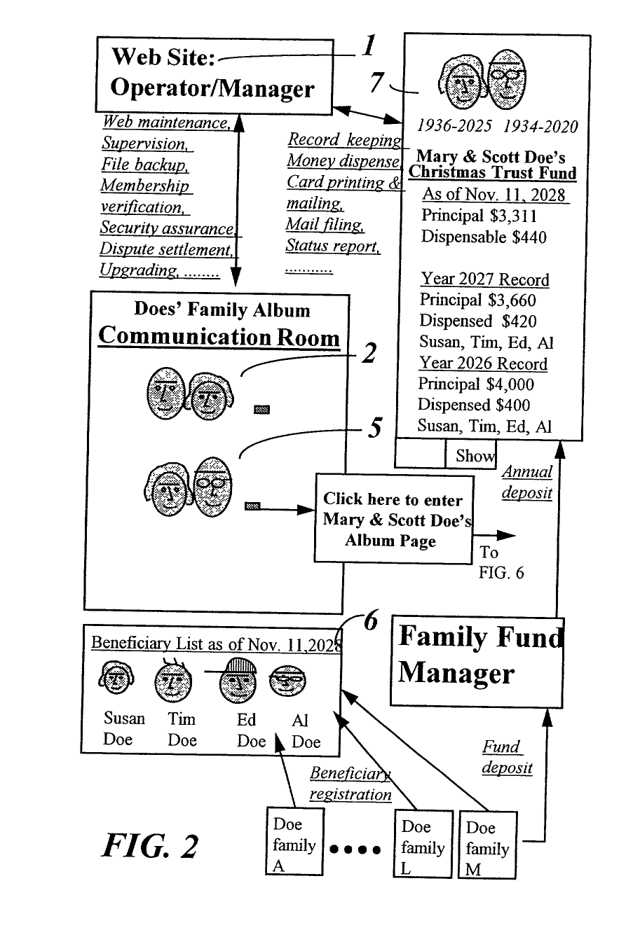

FIG. 2 shows the web site after 21 years, that is in the year of 2028. By then, one more couple Mary and Scott Doe, 5, have been deceased, and a second dedicated fund 7 has been established for them. The beneficiaries are also different, and are Susan, Tim, Ed, and Al, 6. In this example, only children are assumed to be eligible as the beneficiaries. The fund dedicated for Mary and Scott Doe is not large enough to dispense the rewards from the income alone. Accordingly, the principal is seen decreasing every year. Also note that the reward amount is about twice as compared to the example of FIG. 1. This is because it is assumed that the money value would have become almost halved over the 21 years. The reduction of the principal amount is depicted graphically in FIG. 4. The reasons for choosing this way could be varying. Mary and Scott might have thought that it would be enough for them to be remembered about 100 years after their death. Or they might not have enough money.

It should be noted that Mary and Scott Doe could have their own web site, instead of sharing the web site of the elders, namely, Joe and Jenny Doe's. This difference is immaterial in this invention.

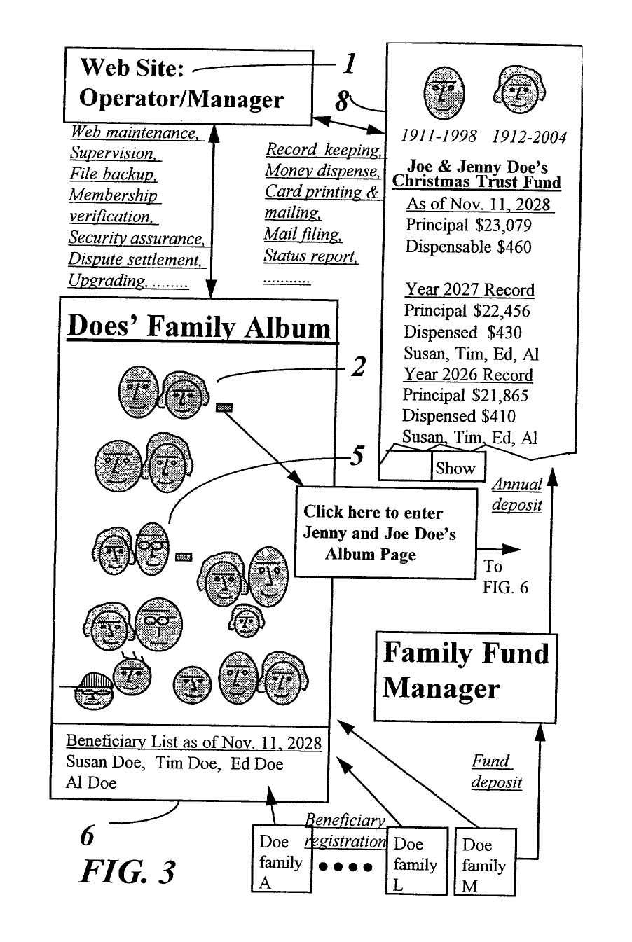

FIG. 3 shows the same case of FIG. 1 and FIG. 2, but shown in a slightly different way. In this case, the funded-relatives Joe and Jenny Doe, 2, and Mary and Scott Doe, 5, are not shown separately as in FIGS. 1 and 2. In FIGS. 1 and 2 a web space named ‘Communication Room’ is used to display all the funded-relatives separately. In FIG. 3, they are shown mingled together with all other relatives, dead or alive. So long as the key points as described above are working, such a variation is immaterial in the teaching of the present invention. It is also seen that the fund principal in the account system 8 for Joe and Jenny Doe has increased almost to a double amount as compared to that of FIG. 1. This is because FIG. 3 is a snap shot taken at 2028, while FIG. 1 is at 2007. We are assuming again that the inflation would have reduced the money value, and the increased amount is to keep the real value about constant.

FIG. 4 shows the values of the fund principals in a constant dollar of year 2005. The curves have minor fluctuations for two reasons. The first reason is that there would be periods when the families do not have small children to withdraw the monetary rewards. During that period all the income from the principal is added to the principal. The second reason is the limitations on the accuracy with which the monetary rewards and inflation could be estimated.

FIG. 5 depicts a procedure through which a new name is registered (Step 1) and is verified (Step 2) through the inquiries among the existing family members. If an objection is raised by any existing family member, the name of the registered will not be added to the beneficiary list, 3 and 6, until the dispute is resolved.

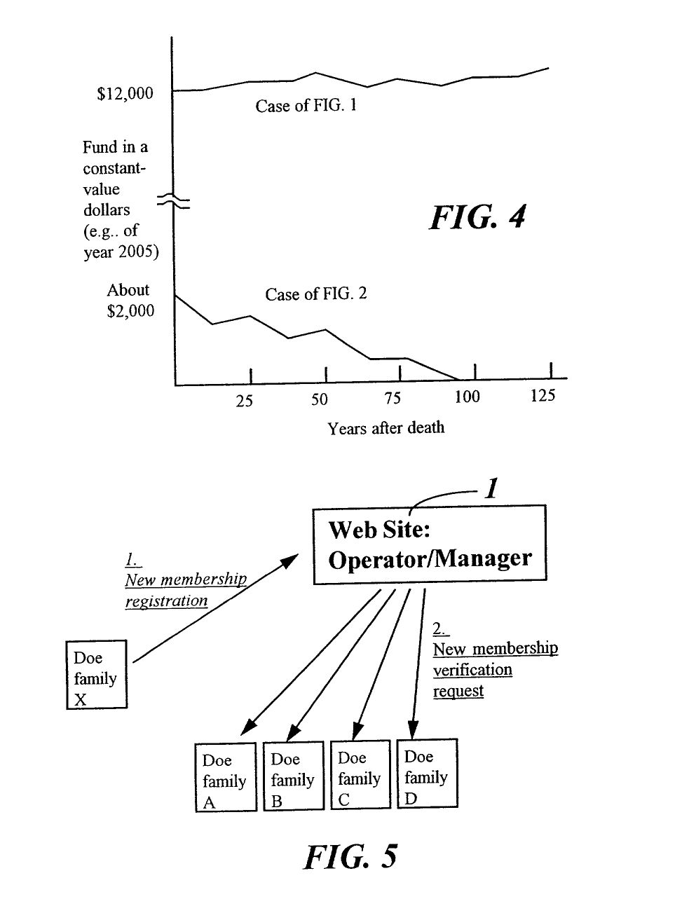

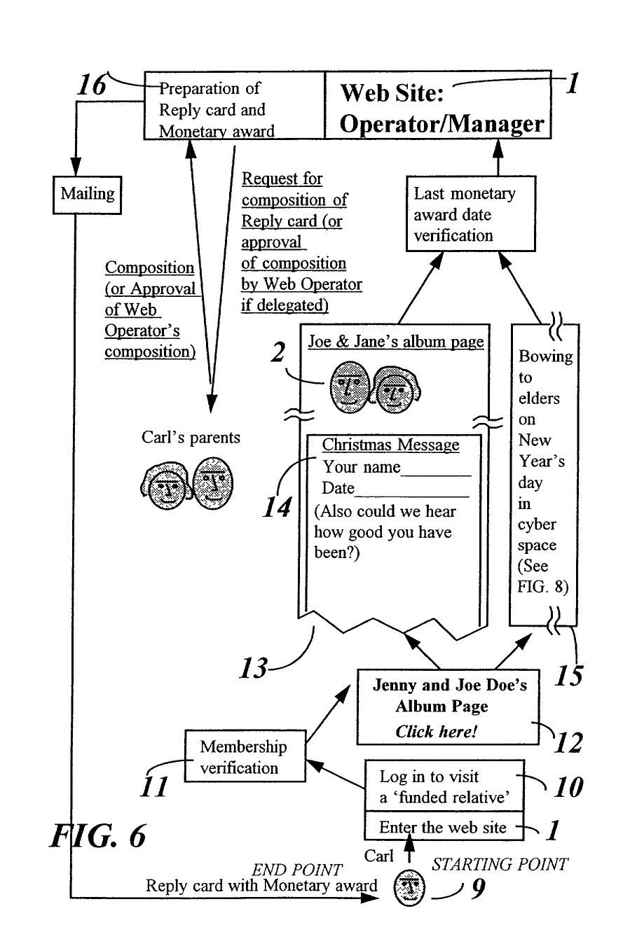

FIG. 6 depicts an example of the complete procedure of the present invention in which Carl, one of the beneficiaries, 3, in FIG. 1, enters the family web site 1 and logs in, 10, to visit the funded relatives 2. The beneficiary-verification program 11 will verify him as a legitimate beneficiary of the time, and let him in. He then enters the gate 12 to the Joe and jenny Doe's web page 13, and leaves a greeting message 14, fulfilling a duty for receiving a monetary reward from the dedicated fund of Joe and Jenny Doe's.

Then the web site would check the last date when Carl withdrew a monetary reward from the same fund dedicated to Joe and Jenny Doe 2. If the date is not prior to a certain designated day, he is denied for the reward. A kid could try to get the rewards every 30 minutes if the web site allows that.

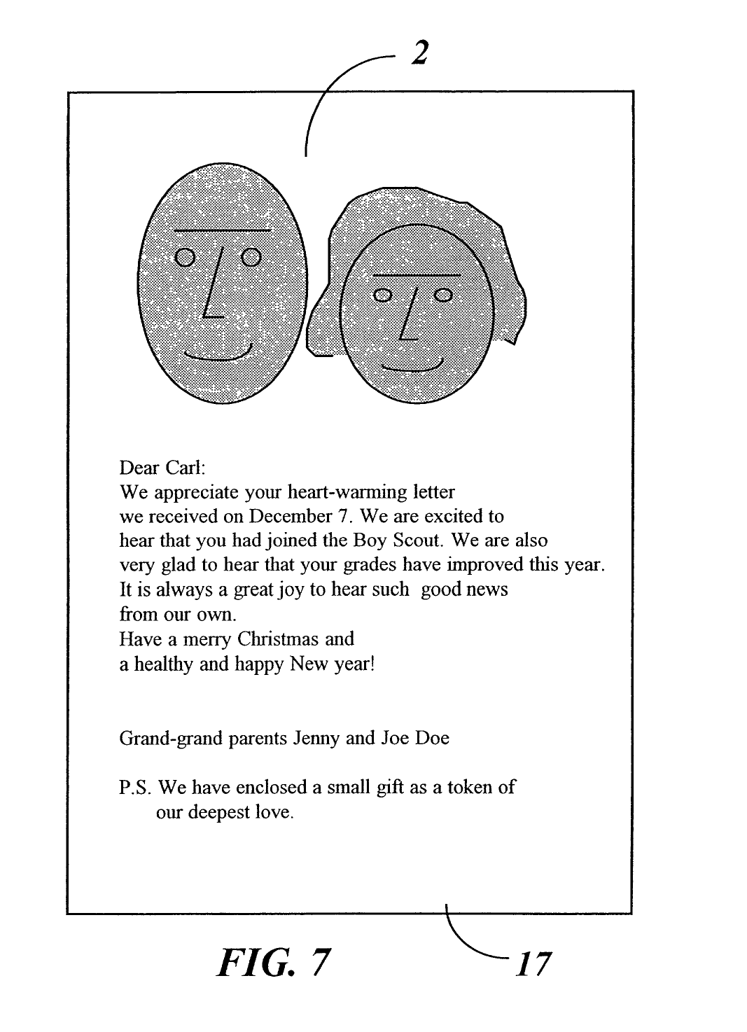

When Carl 9 fills out the greeting message, a greeting reply card may be generated by the web site, and mailed to Carl along with the monetary reward. When the size of the family fund is small, this greeting reply card could be the only monetary reward, even though enclosing some money along with the card is quite desirable. The reply letter may be prepared utilizing the ‘Reply card preparation system’ 16, which mobilizes the input from Carl's parents as depicted in FIG. 6. Such a card would be more personal and meaningful. Or the parents could delegate the letter writing task to the web site operator or manager. FIG. 7 shows an example of a reply card 17 prepared on the behalf of Joe and Jenny Doe 2.

The mailing could be done through the conventional way, namely through a postal system or the likes, or through the internet using cyber cash, cyber gift certificate, cyber bank account, or the likes, especially when the cyber financial techniques are well developed and secure.

If Carl is a descendant of an Asian origin, he might choose ‘Bowing Ceremony’ option 15 instead of writing a letter in FIG. 6. The bowing ceremony option 15 would be displayed on the computer monitor, as depicted in FIG. 8, when he chooses the option 15. There could be other ways to express one's respect to the ancestors, and those ways could be implemented to replace the letter writing 14 or bowing 15.

The present inventions assume that the amount of the typical family funds is not very large, even though there is no limitation in the amount. It is natural to assume that, when the size of the family fund is not large, the beneficiaries would be small children since they would be still excited. When fund size is modest, it would not attract swindlers much.

The internet is quite democratic in that it does not cost much to have an access. It is the main objective of the present invention to enable the ordinary people to preserve their heritage and family root. The objective is achieved mainly by the auto-pilot feature as described. It should not take a king's Pyramid or a rich man's huge fund to achieve that.

It should be noted that the descendants should not be allowed to dismantle the family funds, for example to cash in for their own use, long after the funded-relatives have died, so long as the web site is performing its intended functions dutifully as described above.

The main purpose of the present invention is to devise a means to execute the trust fund successfully, for hundreds of years and beyond, after the funded relative dies. However, many people might like to establish a fund to be managed by the system described in this present invention even before they die. He might want to establish the fund, but want to keep it inactive until he dies. On the other hand, he might want to activate it while he still lives. Since the present invention is configured mainly for dead people, some of its features are unusual, and might not be suitable for a living person. The most objectionable feature would be sending a Christmas present through the web site as described above. Grandparents would surely want to deliver Christmas presents to the kids directly, not through an internet system, unless they are really in bad terms, or the grandparents are very odd people. The other feature objectionable to most of the living people would be the compulsory condition of the present invention that the financial details of their fund be available readily on the web site for the visiting relatives. That would be quite uncomfortable at best, and could be quite troublesome. On the other hand, they suffer from those odd arrangements for ten of years at most, and they would benefit from the system for hundreds of years or longer after they die. In order to give them a temporary relief from suffering caused by the odd arrangements of the present invention while they are living, the system could be slightly altered.

First, the time-window could shift from Christmas (or New Year day) to other period, such as Back-To-School time. Kids could surely use some extra allowance when they are preparing for the school after a long vacation.

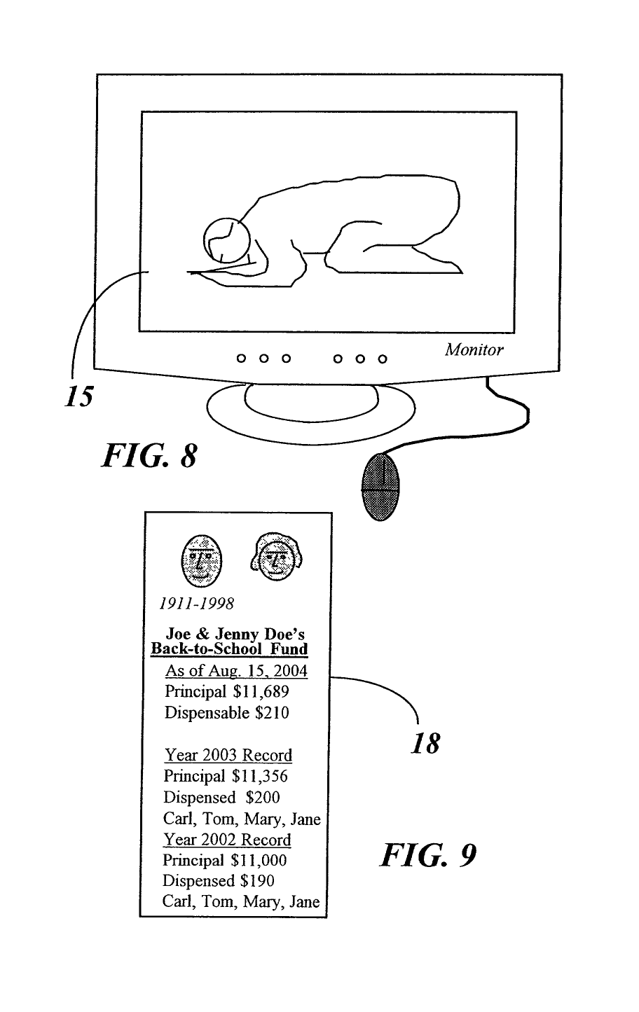

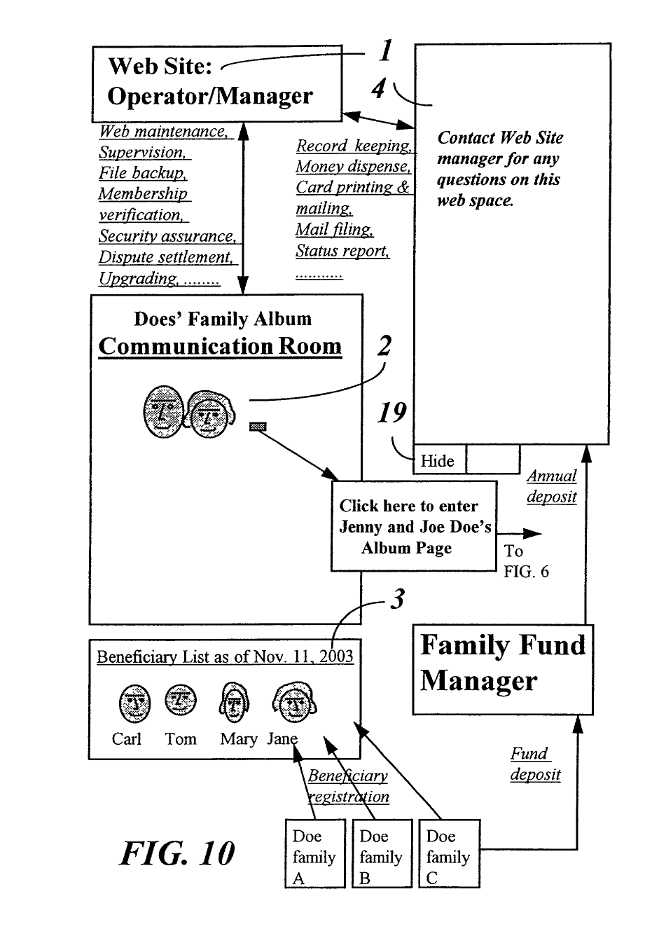

FIG. 9 shows a financial details 18 in which the fund title is altered from Christmas theme of FIG. 1 to Back-To-School theme, since Jenny Doe is alive in 2002 through 2004 in this example; and she dies in late 2004, and the fund is switched to the Christmas theme from 2005, as shown in FIG. 1.

FIG. 10 shows the same as in FIG. 1, except that it is for year 2003, when Jenny Doe is still alive. Note that the option ‘Hide’ 19 is selected and the financial details is not available to the relatives with the selection. Instead, a message “Contact Web Site manager for any questions on this web space.” or the like is on display. When Jenny Doe dies, the financial details become available as shown in FIG. 1. From that point on, and hopefully forever, her and her husband's family fund would be executed smoothly, with her name cherished by her descendants, following the financial management system described earlier in this patent.

Since the purpose of this invention is to maintain private or family web sites of ordinary people over hundreds of years and beyond using private funds as the main incentive to draw in descendants' attention, a key is establishing the fund itself Even $10,000 cash could be too large a sum for many people to come up with to set up his web site following the teachings of the present invention. In order to resolve this potential problem, a savings plan can be set up to establish $10,000 in year 2000 dollars for example, in which people deposit $10 per month over 30 years, depositing $3,600 (=P3) over the 30 years, or $18 per month over 20 years, depositing $4,320 (=P2). The amount P2 should be larger than P3 because the interest of the cumulatively deposited sum will be less when the sum is deposited within a shorter period.

One complication expected is the death of a person who has been depositing. A person could sign on a contract to deposit $10 per month over 30 years, and then could die 12 years later, or 23 years later. It is best that the total target fund ($10,000 in this example) is dedicated to his web site even he dies before he has deposit the total sum. In order to accommodate these unavoidable cases, the monthly deposit should be increased to include a life insurance premium for the total sum. Then total sum could become $11 instead of $10 in this example (or $19 instead of $18 for the 20 year term).

It is assumed that the deposit sum would not be used until the person dies. If the person wants to dispense some monetary rewards while he lives, he should spend that amount in addition to the deposits.

It would be natural to maintain the person's web site all along while he deposits the sum, even though no rewards are dispensed while he lives.

This part concerning raising a fund by multiple deposits is being applied for a patent by a divisional patent with a title of SAVINGS PLAN AND INSURANCE POLICY FOR IT FOR AFTER-LIFE PRIVATE WEB SITES, and thus will be only described but not claimed in this patent application.

Obviously many modifications and variations of the present invention are possible in light of the above teachings. It is therefore to be understood that within the scope of the appended claims the invention may be practiced otherwise than as specifically described.

1. A system for a family fund management based on an internet family web site, comprising:
family funds that are dedicated to some of the relatives individually, who are called funded-relatives, the existence of the family funds being displayed clearly on the family web site;
monetary rewards that are dispensed from the family funds;
beneficiaries; and
financial details of the family funds including the principal amount, income from the principal, dispensable amount, past transactions, monetary rewards that have been dispensed from the family funds, being readily available for display on the web site in a self-explanatory fashion;
wherein, the beneficiaries are allowed to withdraw the monetary rewards from the family funds, whereby the beneficiaries have monetary incentives to visit the family web site, and the clarity and transparency of the financial details available on the family web site allows the family fund executed largely in an auto-pilot mode, and contributes to preserving the family web site over many generations at a reasonable financial management cost, and to reducing the possibility of financial fraud substantially.

2. An invention as in claim 1, wherein the beneficiaries are allowed to receive the monetary rewards mostly during one time period in the year.

3. An invention as in claim 2, wherein the time period is around Christmas.

4. An invention as in claim 2, wherein the time period is around New Year's day.

5. An invention as in claim 1, wherein the beneficiaries are pre-verified for the entitlement to monetary rewards, and the list of beneficiaries are available for display on the web site as to make the family fund management more transparent and predictable.

6. An invention as in claim 1, wherein the beneficiaries are mainly minors.

7. An invention as in claim 1, wherein the monetary rewards are generated from the income of the family funds, and a part of the income is invested back into the family funds so as to prevent reduction in the value of the family funds despite of the inflation.

8. An invention as in claim 7, wherein the income is from an investment that does not have a risk of losing the value of the principal of the family funds.

9. An invention as in claim 1, wherein the monetary rewards include a greeting card created on the behalf of the funded-relatives.

10. An invention as in claim 9, wherein the greeting card has the images of the funded-relatives printed on it.

11. An invention as in claim 9, wherein the content of the greeting cards is prepared with an input from the parents or guardians of the recipient.

12. An invention as in claim 1, wherein the monetary rewards are prepared by a personnel responsible for the family web site and then mailed to the beneficiaries.

13. An invention as in claim 12, wherein the mailing of the monetary rewards is done through the cyber space.

14. An invention as in claim 1, wherein the monetary rewards are awarded when a certain procedure is taken by the beneficiaries on the family web site.

15. An invention as in claim 14, wherein the certain procedure consists of writing a letter to the funded-relatives.

16. An invention as in claim 14, wherein the certain procedure consists of the traditional bowing of the Eastern culture that is performed on the cyber space.

17. An invention as in claim 1, wherein all the funded-relatives are displayed separately in one place on the family web site.

18. An invention as in claim 1, wherein the number of the monetary rewards that one specific beneficiary can withdraw from one specific family fund per year is limited.

19. An invention as in claim 1, wherein the family funds are structured in such a way that the family funds cannot be dismantled by descendants so long as the web site is performing its intended function properly as described on the behalf of the decedents.

20. An invention as in claim 1, wherein the funded-relatives are mostly relatives who are not available because they have been dead or live at a far distance.

21. A system for a family fund management based on an internet family web site, comprising:
a family fund that is dedicated to some of the relatives individually, who are called funded-relatives, its existence being displayed clearly on the family web site;
monetary rewards that are dispensed from the family fund;
financial details of the family fund including the principal amount, income from the principal, dispensable amount, past transactions, and monetary rewards that have been dispensed from the family fund, and
selection means to choose between making the financial details of the family fund being readily available for display on the web in a self-explanatory fashion, and making financial details of the family fund not available for display to others on the web site.

22. An invention as in claim 21, wherein the selections means is chosen to make the financial details of the family fund being readily available for display on the web in a self-explanatory fashion after the funded-relatives die, and the selection means is chosen to make the financial details of the family fund not available for display to others on the web site before the funded-relatives die.

23. An invention as in claim 22, wherein the monetary rewards are not dispensed during the Christmas and New Year before the funded-relatives die.

24. An invention as in claim 23, wherein the monetary rewards are dispensed mostly near the end of school vacations so as to provide the beneficiaries money to buy school supplies.

25. A method for a family fund management based on an internet family web site wherein family funds that are dedicated to some of the relatives are clearly listed on the family web site; and monetary rewards are dispensed from the family funds to beneficiaries who are pre-verified for the entitlement to monetary rewards, the list being readily available for display on the web site; and financial details of the family funds including the principal amount, income from the principal, dispensable amount, past transactions, and monetary rewards that have been dispensed from the family funds, are readily available for display on the web site in a self-explanatory fashion;
whereby the beneficiaries have monetary incentives to visit the family web site, and the clarity and transparency of the financial details available on the family web site allows the family fund executed largely in an auto-pilot mode, and contributes to preserving the family web site over many generations at a reasonable financial management cost, and to reducing the possibility of financial fraud substantially. whereby the beneficiaries have monetary incentives to visit the family web site, and the clarity of the financial transactions and the transparency of the financial details allow the family web site being steered largely in an auto-pilot mode, and contribute to preserving the family web site over many generations at a reasonable financial management cost and to reducing the possibility of financial fraud substantially.
